(19) United States
(12) Patent Application Publication
(10) Pub. No.: US 2015/0067721 A1
(43) Pub. Date: Mar. 5, 2015

(54) METHOD AND SYSTEM FOR TRANSMITTING VIDEOS TO MOBILE PHONES

(71) Applicants: Vidal Andres CADENA VEDOVA, Guayaquil (EC); Diego Andres GUARDERAS HIDALGO, Guayaquil (EC); Jorge Luis BUSTAMANTE APUPALO, Guayaquil (EC); John Luis BALAREZO GALARZA, Guayaquil (EC)

(72) Inventors: Vidal Andres CADENA VEDOVA, Guayaquil (EC); Diego Andres GUARDERAS HIDALGO, Guayaquil (EC); Jorge Luis BUSTAMANTE APUPALO, Guayaquil (EC); John Luis BALAREZO GALARZA, Guayaquil (EC)

(73) Assignee: VMS COMMUNICATIONS LLC, Miami, FL (US)

(21) Appl. No.: 14/012,640

(22) Filed: Aug. 28, 2013

(51) Int. Cl. H04N 21/414; H04N 21/81; H04W 80/12; H04N 21/236; H04W 4/14

(52) U.S. Cl. CPC H04N 21/41407; H04N 21/236; H04W 4/14; H04W 80/12; H04N 21/812
USPC 725/32; 725/62

(57) ABSTRACT

A system and method for transmitting a video to a mobile phone include extracting a clip from a digitally encoded video, then editing and compressing the clip. The compressed clip is transmitted for display at a mobile phone in response to a request from the mobile phone for access to the clip. The request is initiated through a Wireless Application Protocol (WAP) link contained in a Short Message Service (SMS) text message transmitted to the mobile phone.

### FIELD OF THE INVENTION

The present invention relates to a method and a system for transmitting videos to mobile phones for display to users of the mobile phones. Display includes real-time streaming of a video feed, as well as display of videos downloaded onto the mobile phones.

### BACKGROUND INFORMATION

Currently, there exist few practical ways to transmit video to mobile phones. One way for mobile phone users who desire access to videos is to use a web browser to obtain a video from an Internet source. A user might, for example, open a web page using the browser and select a video on the page for viewing. The video would, in this instance, be delivered using standard Internet protocols. A disadvantage of Internet transmission is that not every mobile phone has a web browser. Although many of the phones currently being produced, such as so-called “smart phones,” include built-in web browsers, there are still many mobile phones in production that do not have web capability. Another disadvantage of Internet transmission is that it can be data intensive. Data is used not only to browse web pages containing the videos, but also for transmitting the videos. Often, neither the web pages nor the videos are optimized for use with mobile phones. For example, web pages may contain unnecessary scripts or large image files, and videos may be of excessive length and file size. This is a concern for many users, who are not subscribed to unlimited data usage plans, and therefore are limited to a certain amount of data that can be transmitted to and from their phone in each billing period. Even users with unlimited plans may find using a web browser to access videos an unpleasant experience because of the time it takes to download large files.

An alternative to Internet transmission is to use a multimedia messaging service (MMS), which is an extension of short message service (SMS). Whereas SMS is used to send text messages, MMS allows multimedia content such as images, audio files, and video files to be delivered to and from mobile phones. A disadvantage of MMS is that many phones are not MMS capable. Even where a phone is MMS capable, the phone may need to be configured before being able to send and receive MMS messages. Additionally, there is no standard MMS implementation, with different phone manufacturers specifying their own implementation so that multimedia content in an MMS message may not be compatible for all brands of MMS capable phones.

### BRIEF DESCRIPTION OF THE DRAWINGS

FIG. 1 is a block diagram of a system for transmitting videos to mobile phones, according to an example embodiment of the present invention.

FIG. 2 is a block diagram of a system for transmitting videos to mobile phones, according to an example embodiment of the present invention.

FIG. 3 is a flowchart of a method for generating videos for transmission to mobile phones, according to an example embodiment of the present invention.

FIG. 4 is a flowchart of a method for editing videos that are generated for transmission to mobile phones, according to an example embodiment of the present invention.

FIGS. 5 to 7 are figurative representations of video editing according to an example embodiment of the present invention.

FIG. 8 is a flowchart of a method for transmitting videos to mobile phones, according to an example embodiment of the present invention.

FIG. 9 shows example SMS messages transmitted in connection with the method of FIG. 8.

### SUMMARY

Example embodiments of the present invention relate to systems and methods for transmitting videos to mobile phones.

According to example embodiments, a system and method for transmitting videos to mobile phones involve extracting a clip from a digitally encoded video, editing the clip, and compressing the clip after the editing. The editing and compression ensure that the clip can readily be transmitted to a mobile phone without consuming excessive bandwidth or data. The compressed clip is then transmitted for display at the mobile phone in response to a request from the mobile phone for access to the clip.

According to example embodiments, the request for transmission of the video clip is initiated through a Wireless Application Protocol (WAP) link in a Short Message Service (SMS) text message transmitted to the mobile phone. The clip is then transmitted using a WAP portal and delivered to a WAP browser at the mobile phone. This allows phones that do not include a web browser to access the clip. It also avoids the need to browse a data intensive web page to locate the clip. In an example embodiment, the link is transmitted based on a user subscription, allowing the user to receive notifications of new clips that are of interest to the user.

According to example embodiments a WAP link can directly link to a clip or link to a WAP page containing a direct link to the clip. The WAP page allows a plurality of related clips to be organized for display to and selection by a user of a mobile phone, using a WAP browser.

### DETAILED DESCRIPTION

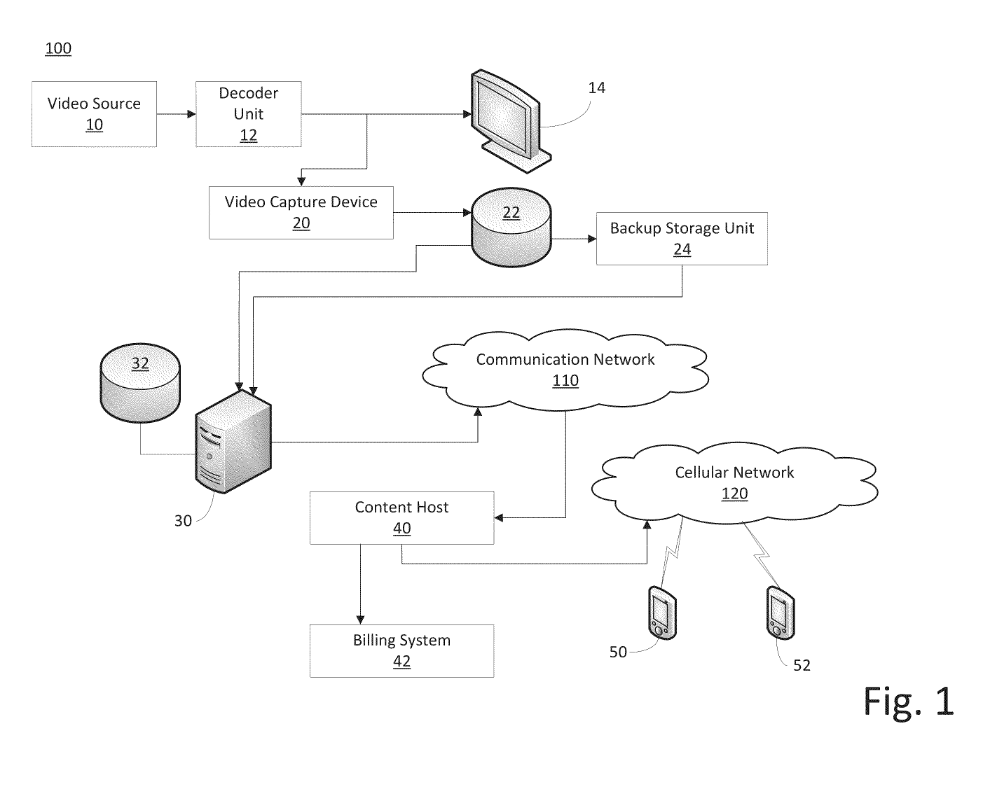

FIG. 1 shows a system 100 for transmitting videos to mobile phones according to an example embodiment of the present invention. The system 100 may include a video source 10, a decoder unit 12, a television 14, a video capture device 20, a storage unit 22 and a backup storage unit 24. The video source 10 can be a provider of paid television services such as a cable or satellite service. The video source 10 feeds an encoded video signal into the decoder unit 12, which decodes the video signal for transmission to the television 14. The decoded signal may be analog or digital.

The decoded video signal is transmitted to the capture device 20 in parallel with the transmission to the television 14. Where the decoded signal is analog, the capture device 20 may include an analog-to-digital converter, such as a serial digital interface (SDI) converter that converts the decoded signal into a digital signal, thereby creating a digital video corresponding to the decoded signal. The digital video is then forwarded to the storage unit 22 for storage. Where the decoded signal is digital, the capture device 20 may generate the digital video without any conversion. The capture device 20 may be configured to generate the digital video by converting or recording the decoded signal over a specified time period that coincides with a particular event such as a sports game or a television show.

The storage unit 22 may be any conventional storage medium including, for example, an optical hard drive or solid state drive. The storage unit 22 may be externally connected or built into the capture device 20. Digital videos stored at the storage unit 22 may be copied to the backup storage unit 24 to ensure that at least one copy of all digital videos is preserved. The backup storage unit 24 may also include an optical or solid state drive in addition to hardware or software to control the frequency with which the digital videos are copied. In one embodiment, the backup storage unit 24 is a network-attached storage (NAS) device, and in particular a NAS device including a plurality of storage drives that are configured for redundant storage of the contents of the storage unit 22, e.g., using a redundant array of independent disks (RAID) configuration.

The system 100 may further include a central computer, e.g. a server 30, a database 32, a communication network 110, a cellular network 120, a content host 40, a billing system 42 and a plurality of mobile phones 50, 52. The server 30 is configured to obtain the digital videos from the storage unit 22 or the backup storage unit 24. Digital videos can be transmitted to the server 30 in response to a command from an operator of the server 30 or at predefined times. The transmission of the digital videos to the server 30 may occur while the capture device 20 continues to create new digital videos. In an example embodiment, the digital videos correspond to live televised events and are transmitted contemporaneously with the events. For example, the digital videos may correspond to a recent portion of a live sports game. Preferably, the digital videos are also processed at the server 30 contemporaneously with the events, so that the mobile phone users can access the corresponding videos while the events are still occurring. This is especially advantageous in the sports context because users may want frequent video updates on the progress of a sports event.

As will be explained below, the server 30 processes the digital videos, editing and converting them into suitable file formats for transmission to a mobile phone 50, 52. Processed videos may be stored at the database 32 or in a local storage medium at the server 30. The processed videos are then transmitted to the content host 40 through the network 110. In an example embodiment, transmission to the content host 40 involves secure file transfer protocol (SFTP). Other transmission methods may be used additionally or alternatively, including satellite transmission, email, virtual private networking, or using a Simple Object Access Protocol (SOAP) connection. The database 32 may, in addition to storing the processed videos, store data used for the editing of the videos. This data may include videos that were not recorded by the capture device 20, but which may be appended to or spliced into the digital videos, image files that may be inserted into the digital videos, and files that support various audio or visual effects.

Algorithms for generating, editing or transmitting video, which algorithms are performed by a hardware processor of a computer in a system according to an embodiment of the present invention (for example, the server 30), may be stored as program code on a non-transitory computer readable medium including any conventional memory device, to perform any of the methods described herein, alone or in combination, e.g., to output any one or more of the described graphical user interfaces. The memory device can include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

The content host 40 stores and manages the processed videos that it receives from the server 30, and is responsible for transmitting the processed videos for display at the mobile phones 50. The system 100 may include a plurality of content hosts, each hosting a specific type of video content. For example, one content host may store videos relating to sports events or a specific form of sport such as soccer, while another content host stores videos relating to movies or television shows. As will be explained, content hosts may use SMS messages to transmit WAP links to hosted videos. The WAP links are displayed in the body of an SMS message and connect to a wireless application protocol (WAP) portal through a WAP browser on a mobile phone. Most mobile phones, including many legacy phones, have built-in WAP browsers. In this manner, videos may be delivered for streaming at or for download onto many different types of existing mobile phones.

Each content host may control or monitor access to hosted videos, and then bill the users of the mobile phones 50, 52 for the access. In an example embodiment, access is subscription based, with mobile phone users subscribing to a specific video service offered by a particular content host (e.g., all videos relating to games in a particular soccer league). Where the videos are sports related, the subscription may be tied to a sports season so that the subscription coincides with the beginning and end of the season. Similarly, where the videos are television related, the subscription may coincide with a television season for a particular television network or for a particular television show. Billing may also be performed on a per access basis. The billing system 42 manages subscriptions and billing for one or more content hosts, including the host 40.

The cellular network 120 is controlled by a mobile phone operator, which may or may not be the same entity as the content host 40. The cellular network 120 provides conventional mobile phone services such as voice and SMS based text messaging for the mobile phones 50, 52. In addition, the cellular network 120 provides the infrastructure for the above-mentioned WAP portal, through which portal videos are transmitted from the content host 40 to the mobile. Where the content host 40 is a separate entity, additional WAP portals may be implemented in other cellular networks so that the same hosted videos may be accessed by mobile phone users associated with the other cellular networks.

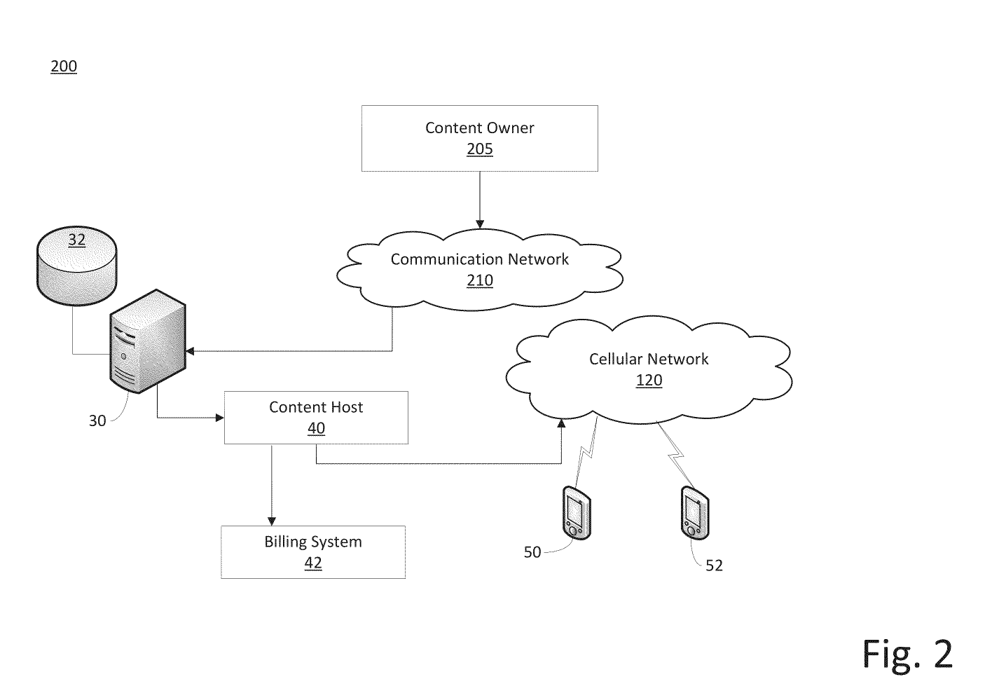

FIG. 2 shows a system 200 for transmitting videos to mobile phones according to an example embodiment of the present invention. The system 200 includes the server 30, the database 32, the content host 40, the billing system 42, and the cellular network 120. The system 200 differs from the system 100 in that the digital videos are transmitted to the server 30 from a content owner 205 through a communication network 210. Similar to the network 110, transmission through the network 210 may be implemented using SFTP, email or other conventional networking technologies.

The content owner 205 is an entity that owns a right to publicly display, or transmit for public display, the digital videos that the content owner 205 transmits to the server 30. The content owner 205 may be an original creator of the digital video or an entity that has a license to the digital video. For example, where the digital videos are sports games, the content owner 205 may be an entity that has a broadcast license to those games. The content owner 205 may, but need not be, the exclusive owner of such rights. In an example embodiment, the server 30 may receive and process digital videos from a plurality of content owners to create a library of videos that are transmitted to one or more content hosts for access by mobile phone users.

Example methods for generating, editing and transmitting videos to mobile phones will now be described. The example methods may be performed in any of the previously described systems according to the present invention. The methods may also be performed independently of the above described systems.

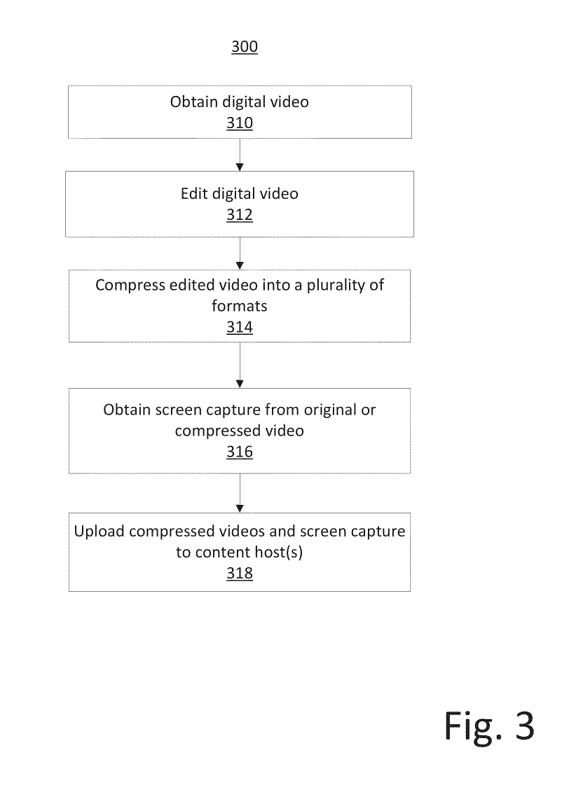

FIG. 3 is a flowchart of a method 300 for generating videos for transmission to mobile phones, according to an example embodiment of the present invention. At step 310, a digital video is obtained from a video source such as the capture device 20 of FIG. 1 or the content owner 205 of FIG. 2. The digital video is temporarily stored for processing, e.g., at the server 30.

At step 312, the digital video is edited by removing unwanted frames and resizing to an aspect ratio suitable for display on a mobile phone, thereby producing a video clip. Video effects may be added and optional filters may be applied to enhance the image quality by, for example, adjusting contrast or brightness.

At step 314, the edited video is compressed into a plurality of file formats. Example formats include a 3rd Generation Partnership Project file format (e.g., 3GP or 3G2) or a Moving Picture Experts Group file format (e.g., MPEG-4 Part 14, also known as MP4) using different compression schemes such as MPEG-4 Part 2, H.263 or H.264. In addition to differences in the compression scheme or the file format used, each compressed video may have a specific resolution or aspect ratio, e.g., 320×240 pixels. This ensures that there exists a version of the edited video that is suitable for display on any one of various mobile phone models, since not every phone has the same size display screen or supports the same file formats. In an example embodiment, the edited videos are compressed without audio in order to reduce file size and optimize transmission. However, the compressed videos may optionally include audio, in which case any suitable audio compression scheme may be used.

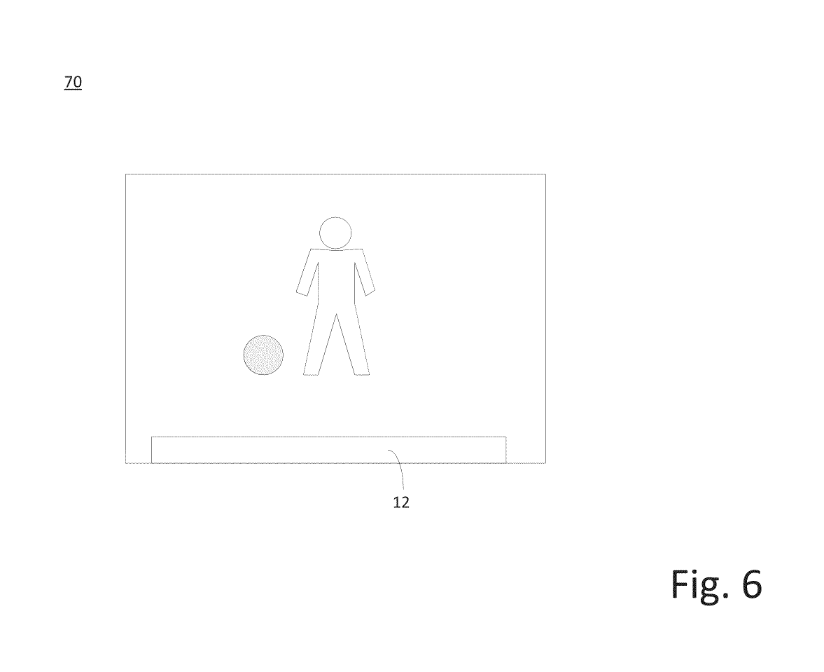

At step 316, a screen capture is obtained from the original digital video or the compressed video. The screen capture is an image file that corresponds to a particularly relevant portion of the compressed video, and therefore may be used to visually signal the contents of the compressed video to a mobile phone user. For example, where the video is of a soccer game, the screen capture may correspond to a moment when a goal is scored. The screen capture may be resized relative to the original or compressed video, e.g., by cropping the image to focus on the goal-scoring player. FIG. 6 is a figurative representation of a screen capture 70 of a goal-scoring player. The screen capture may be saved in a standard file format such as JPEG or GIF. The image size of the screen capture (e.g., 400×400 pixels) is preferably larger than that of the compressed video, since image details are generally more important for static images than moving images.

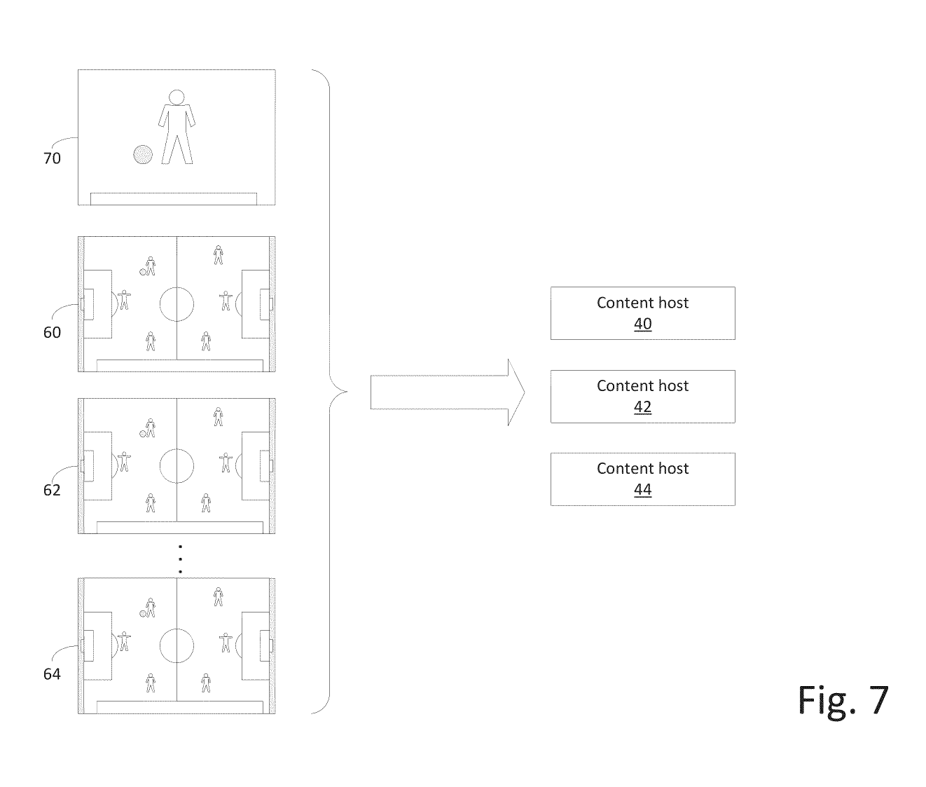

At step 318, the screen capture and the compressed videos are uploaded to one or more content hosts for transmission to mobile phones. Preferably, each content host receives the screen capture and at least one corresponding compressed video, and then stores the compressed video(s) in association with the screen capture. FIG. 7 shows the transmission of a screen capture 70, together with corresponding compressed videos 60, 62 and 64, to a plurality of content hosts 40, 42, 44. As will be explained, the screen capture may be displayed to a mobile phone user, and when the screen capture is selected, the content host transmits a corresponding compressed video for display at the mobile phone.

The editing and compression steps described above may be performed manually using existing video and image processing software. For example, the editing may be performed using Apple Inc.'s Final Cut Pro, and the compression may be performed using a video converter from Xilisoft Corp. Alternatively or additionally, various editing or compression steps may be automated. For example, software may be configured to automatically obtain and compress the edited video into each of the plurality of file formats, without human intervention.

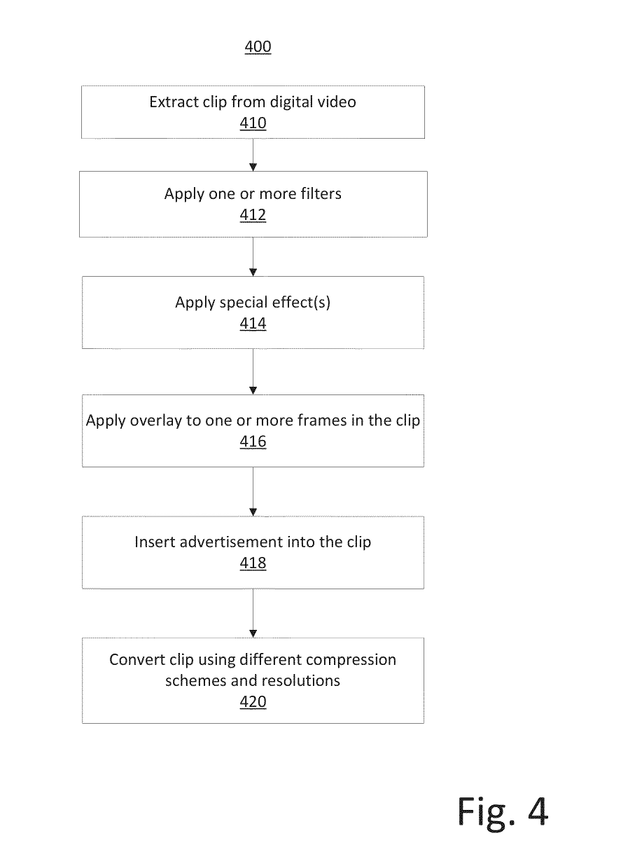

FIG. 4 is a flowchart of a method 400 for editing videos that are generated for transmission to mobile phones, according to an example embodiment of the present invention. The method 400 may be used to implement the editing step 312 of the method 300. At step 410, a video clip is extracted from the original digital video. A human editor at the server 30 may, for example, specify the beginning and ending frames of the original video that correspond to the video clip. The video clip need not be a single continuous segment of the original video. For example, a plurality of segments may be spliced together to form a highlight reel that covers several goals scored during a single soccer game. The total duration of the video clip depends on the type of content being transmitted, and for a sports game may vary from a few seconds to approximately one minute.

At step 412 one or more filters are applied to the video clip. The filter may include conventional image processing filters to enhance image quality by, for example, de-noising, adjusting contrast, brightness or color saturation, or applying color correction. In one embodiment, the filters are applied to reduce the total number of colors used. For example, where the video clip uses the same color in a variety of different tones, the filters may reduce the number of tones by a specified amount. This reduces the photo-realism of the video clip, but has the advantage of enhancing transmission and playback, since the compressed video resulting from the clip will have a smaller file size. The number of tones may be selected to optimize the performance tradeoff between photo-realism and transmission or playback. Alternatively or additionally, there may be a limit on the total number of colors used, e.g., 8-bit or 16-bit color encoding.

At step 414, special effects may be applied. In the soccer example, the special effects may include adjusting color to emphasize players relative to the background, e.g., the grass on the soccer field. A goal-scoring player may be emphasized relative to other players. Different players may be emphasized in turn as the ball gets passed around. The ball itself may also be emphasized. Color may be emphasized by, for example, displaying players using more vivid color or displaying a colored outline around the players' bodies. Other special effects may include adding screen wipes or fadeouts to facilitate the transition from one portion of the video clip to another. Where the video clip is to be compressed with audio, the special effects may include sound effects such as the addition of pre-recorded audio tracks or increasing the volume in the moments leading up to the scoring of a goal.

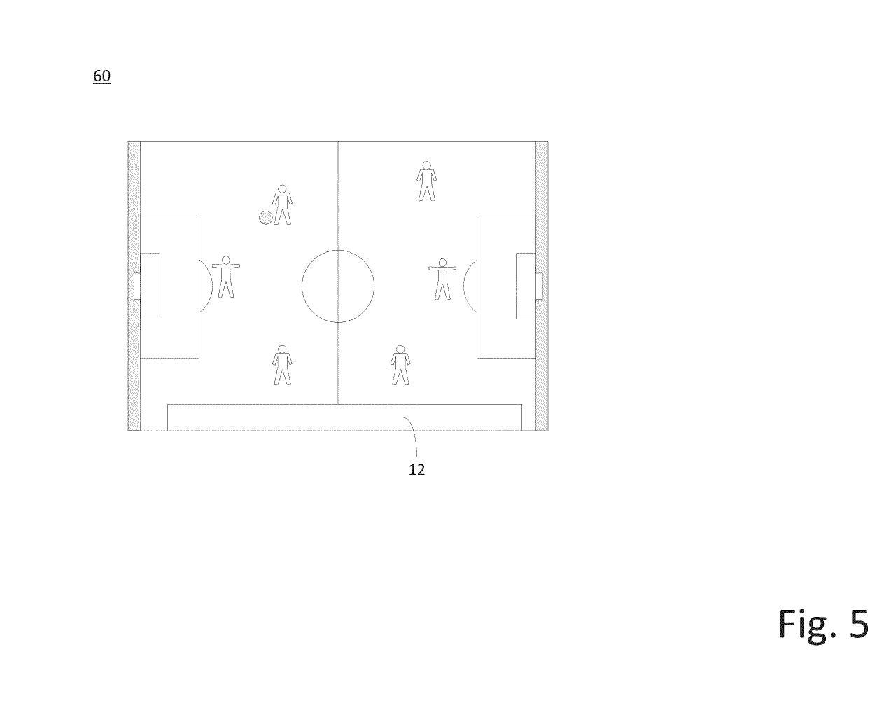

At step 416, an overlay is applied to one or more frames in the video clip. As shown in FIG. 5, an example video clip 60 may include an overlay 12 located at the bottom portion of the frame. The overlay 12 may be used to display information about the contents of the video clip. The overlay 12 may include a text summary of the teams and the current score, e.g., “Ecuador 3-Paraguay 1.” The name of the goal-scorer may be displayed together with a team abbreviation, e.g., “Benitez (ECU).” The time at which a goal is scored can also be displayed, e.g., “Minute 53.” All of this text information may be displayed together in the same overlay or in different overlays throughout the video clip. In the sports context, the overlay is preferably opaque so as to prevent text in the overlay from being obscured by underlying text or graphics. However, the overlay may also be set transparent to minimize the obstruction of the video content. In addition to the overlay, the video clip may be stretched to render illegible any logos or obtrusive content in the lower portion of each frame.

At step 418, an advertisement is inserted into the video clip. The advertisements may be obtained from the database 32, which may store images or videos corresponding to advertisements for products or services offered by the content owner or a business partner of the content owner. The advertisement may be displayed in an overlay, e.g., in a frame that does not already have an existing overlay or in a portion of an existing overlay, which portion does not interfere with text in the existing overlay. Alternatively, the advertisement may be inserted in its own set of frames to form a discrete video segment.

The result of the steps 410 to 418 is a video clip of relatively short duration, e.g., approximately thirty seconds, and high image quality. In one embodiment, the video clip is compressed using a QuickTime animation codec, with a data rate of approximately 30 frames per second, a color depth of millions of colors (essentially no limit on the number of colors used). Additionally, the video clip may be cropped to obtain a desired resolution, e.g., 320×240. A video generated in accordance with these parameters may have a file size of approximately 250 megabytes and a relatively large (for a mobile phone display) image size, e.g., 1920×1080.

At step 420, the video clip is converted into different file formats using various compression schemes, screen resolutions and durations. Example resolutions include 128×96, 176×144, and 320×240. Compression reduces the file size to less than 1 megabyte, making the file suitable for download or streaming using typical cellular network data transmission rates. For example, the compression may set the data rate for the video clip to anywhere between 250 and 300 kilobits per second. The compression may lower the frame rate, e.g., to 15 frames per second. The compression may also optimize the video clip for either downloading or streaming. Example compression schemes include MP4, 3GP using H.263 video compression, and 3GP using H.264 video compression. As mentioned earlier, this allows for optimal playback on different mobile phones. For example the 3GP file format is optimal for phones that operate on third generation (3G) cellular networks, but is also suitable for some 2G and 4G phones. Regarding resolution, the 320×240 size is optimal for BlackBerry phones.

The name of each video file may be used to indicate the contents and the compression format. In the soccer example, a first portion of the file name may correspond to the teams and the current score (e.g., “bar1mac0”) and a second portion of the file name may correspond to the file format (e.g., “128×96_MP4_{—}30S.mp4). Thus, a complete file name for a thirty second video might be “bar1mac0_{—}128×96_MP4_{—}30S.mp4.” Similarly, the file name might be “bar1mac0_{—}176×144_{—}3GP_H263_{—}30S.3gp” for an H.263 encoded version of the same thirty second video. Similarly, a sixty second version of the same video encoded using H.264 video compression might be named “bar1mac0 176×144_{—}3GP_H264_AAC_{—}60S.3gp.

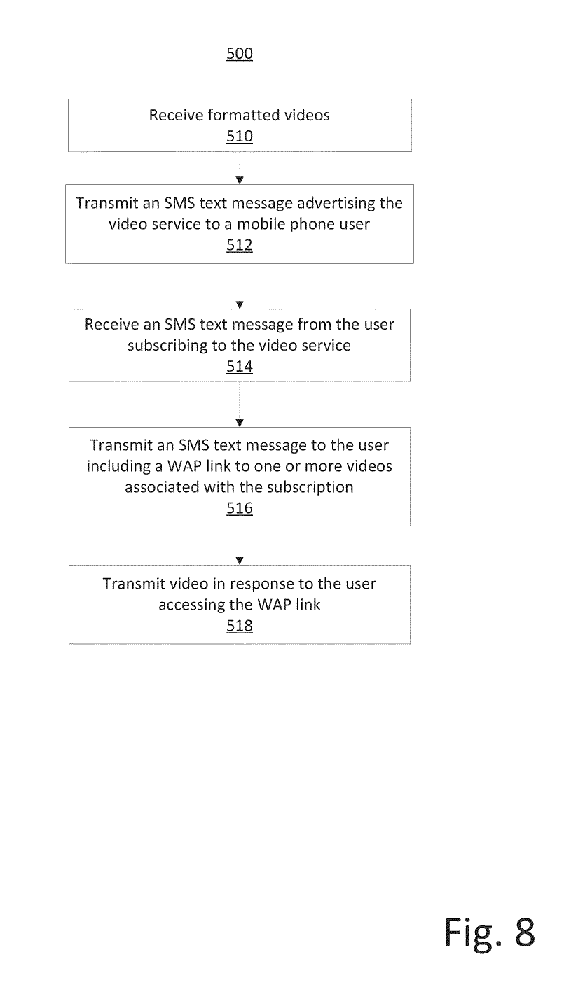

FIG. 8 is a flowchart of a method 500 for transmitting videos to mobile phones, according to an example embodiment of the present invention. The method 500 may be performed at a content host in collaboration with a cellular network operator. At step 510, the formatted videos are received. As mentioned earlier, there exist a number of ways to transmit the formatted videos to the content provider, including using SFTP.

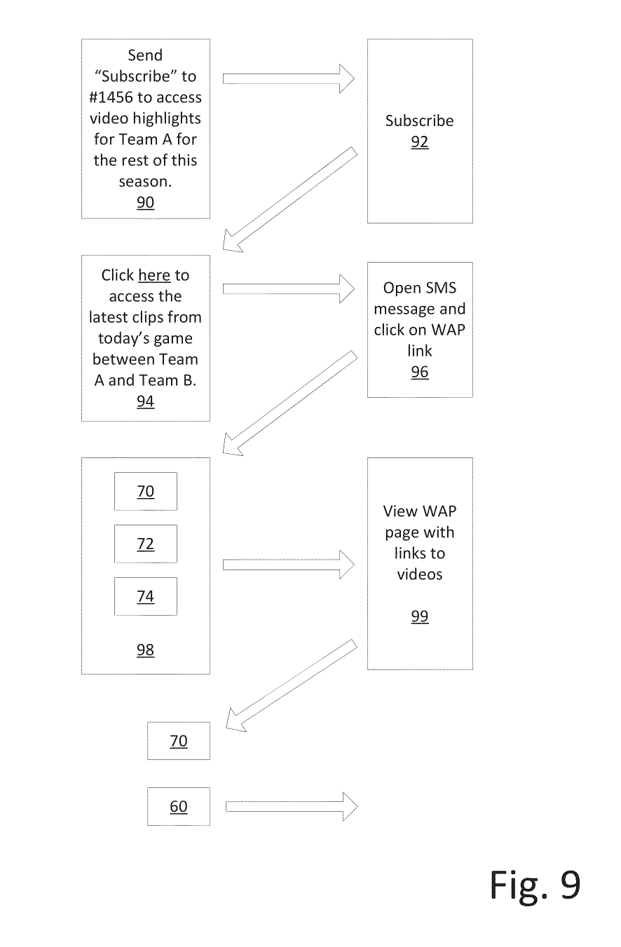

At step 512, an SMS text message is transmitted to a mobile phone user. An example text message 90 is shown in FIG. 9 and includes instructions for sending a reply message that results in the content host adding the mobile phone user to a subscription list. In one embodiment, the content host sends a follow-up message to confirm that the user wants to activate the subscription, e.g., “reply ‘Yes’ to activate subscription.” The follow-up message may also include instructions for canceling a subscription, e.g., “reply ‘Cancel’ to cancel subscription.”

At step 514, the content host receives a text message 92 from the user indicating that the user wishes to subscribe to the video service. The text message 92 may be transmitted in response to viewing the message 90 or because the user learned of the service from another source, such as an Internet or radio advertisement.

At step 516, the user is subscribed to the video service and the content host transmits a text message 94 to the user. The message 94 includes a WAP link to a hosted video or a WAP link to a WAP page containing links to a plurality of hosted videos. The frequency with which such messages are transmitted may depend on a user specified preference, e.g., daily or weekly. Transmission of the message 94 may be event triggered. In the soccer example, a video clip may be generated for every goal scored in every game of a particular soccer league. A user may subscribe to receive messages whenever a goal is scored regardless of which team scored. A user may alternatively subscribe to receive messages for all goals in any game involving a specific team, or to receive messages only for goals scored by a specific team.

The user receives the message 94, and then accesses the WAP link by clicking on it (96). Where the WAP link is to a video, accessing the link results in the video being transmitted (step 518). Prior to transmitting the video, the content host may check whether the user has a subscription that allows the user to view the video. If the user does not have a subscription or if the user's subscription is not associated with the video, the content host does not proceed with transmission. The video may be transmitted for download and a media player application on the user's mobile phone may automatically play the video after the downloading is complete. Some phones may support video streaming, in which case accessing the link causes the video to play without requiring a complete download. Where the content host stores the same video in different formats, the content host may determine, based on information concerning the user's phone (e.g., the manufacturer, the operating system, or the model number), which format is most appropriate for transmission. Additionally or alternatively, the most appropriate format may depend on how the cellular network 120 is configured, as some cellular networks may only support transmission of a specific file format such as 3GP or MP4.

In one embodiment, the content host sends only one message per game, the single message containing a link to a WAP page 98 that is updated during the course of a game to include all videos associated that particular game. The WAP page 98 may be updated whenever an associated video is transmitted to the content host from the server 30. To access newly added videos, the user need only refresh the WAP page 98, which may be specifically designed to be less data intensive compared to video-containing web pages that are accessed over the Internet.

In one embodiment, the WAP links are transmitted together with corresponding screen captures. The text of the WAP link need not be displayed when the user views the WAP page (99) or the text message (96) containing the WAP link. Instead, the WAP link is embedded in the screen capture and accessed when the user clicks on the screen capture. Thus, each hosted video may be represented using a corresponding screen capture 70, 72, 74. For example, when the user clicks on the screen capture 70, the content host may determine that out of the videos 60, 62, 64 corresponding to the screen capture 70, the video 60 is most appropriate for the user's phone, and then transmits the video 60 for display at the user's phone.

An example embodiment of the present invention is directed to one or more processors, which can be implemented using any conventional processing circuit and device or combination thereof, e.g., a Central Processing Unit (CPU) of a Personal Computer (PC) or other workstation processor, to execute code provided, e.g., on a hardware computer-readable medium.

An example embodiment of the present invention is directed to a non-transitory, hardware computer-readable medium, e.g., as described above, on which are stored instructions executable by a processor to perform any one or more of the methods described herein.

An example embodiment of the present invention is directed to a method, e.g., of a hardware component or machine, of transmitting instructions executable by a processor to perform any one or more of the methods described herein.

Example embodiments of the present invention are directed to one or more of the above-described methods, e.g., computer-implemented methods, alone or in combination.

The above description is intended to be illustrative, and not restrictive. Those skilled in the art can appreciate from the foregoing description that the present invention may be implemented in a variety of forms, and that the various embodiments can be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and appendices. Further, steps illustrated in the flowcharts may be omitted and/or certain step sequences may be altered, and, in certain instances multiple illustrated steps may be simultaneously performed.

1. A computer-implemented method for transmitting a video clip to a mobile phone, comprising:
at a processor of a computer, extracting the clip from a digitally encoded video;
editing the clip;
compressing the clip after the editing; and
transmitting the compressed clip for display at the mobile phone in response to a request from the mobile phone for access to the clip;
wherein the request is initiated through a Wireless Application Protocol (WAP) link in a Short Message Service (SMS) text message transmitted to the mobile phone.

2. The method of claim 1, further comprising:
generating the digitally encoded video by using a capture device to capture a live video signal from a paid television provider.

3. The method of claim 1, wherein the compressing includes compressing the clip into a plurality of file formats for transmission to mobile phones that support different ones of the plurality of file formats.

4. The method of claim 3, wherein the file formats include 3GP and MP4 formats.

5. The method of claim 3, wherein the file formats include a plurality of different display resolutions, each resolution corresponding to a display size of a particular model of mobile phone.

6. The method of claim 1, wherein the editing includes overlaying the clip with text information that describes a content of the clip.

7. The method of claim 1, wherein the editing includes inserting an advertisement into the clip.

8. The method of claim 1, wherein the editing includes reducing a frame rate of the clip.

9. The method of claim 1, further comprising:
capturing an image from one of the digitally encoded video or the compressed clip; and
outputting the captured image for display at the mobile phone prior to transmitting the compressed clip.

10. The method of claim 1, further comprising:
transmitting the SMS text message to the mobile phone, wherein the WAP link is a link to one of the clip or a WAP page containing a link to the clip; and
receiving the request from the mobile phone.

11. The method of claim 10, wherein the SMS text message is transmitted in response to determining that the mobile phone is subscribed to a video service associated with the clip.

12. The method of claim 11, further comprising:
subscribing the mobile phone to the video service in response to a second SMS text message from the mobile phone.

13. The method of claim 1, further comprising:
storing the clip in a plurality of compressed file formats, the file formats including different display resolutions; and
selecting one of the file formats for transmitting the clip based on identifying a display capability of the mobile phone.

14. The method of claim 1, wherein the WAP link is to the WAP page containing a link to the clip, the method further comprising:
providing links to a plurality of clips on the WAP page;
displaying each of the plurality of links using an image captured from one of the respective clip or a digital video from which the respective clip was derived.

15. The method of claim 1, wherein the clip contains video coverage of a live event, and the transmitting is performed contemporaneously with the event.

16. The method of claim 15, further comprising:
transmitting a follow-up SMS text message to the mobile phone to indicate an availability of clips that contain new video coverage of the event.

17. The method of claim 15, wherein the WAP link is to the WAP page containing a link to the clip, the method further comprising:
updating the WAP page to include additional links to clips that contain new video coverage of the event.

18. (canceled)

19. (canceled)

20. (canceled)
